(19) United States
(12) Patent Application Publication
(10) Pub. No.: US 2026/0083231 A1
(43) Pub. Date: Mar. 26, 2026

(54) DISPENSING HEAD FOR FLUID PRODUCT DISPENSER AND ASSOCIATED DISPENSER

(71) Applicant: ALBEA SERVICES, Gennevilliers (FR)

(72) Inventors: Gaël THOREZ, Gennevilliers (FR); Rafael LORETO VENTURA, Gennevilliers (FR); Victor RAMOS, Gennevilliers (FR)

(73) Assignee: ALBEA SERVICES, Gennevilliers (FR)

(21) Appl. No.: 19/309,095

(22) Filed: Aug. 25, 2025

(30) Foreign Application Priority Data
Sep. 24, 2024 (FR) 2410181

(51) Int. Cl. A45D 34/04

(52) U.S. Cl. CPC A45D 34/04; A45D 2200/055

(57) ABSTRACT

A dispensing head for a fluid product is adapted to mount on a fluid product reservoir of a dispenser. The dispensing head includes a pump actuator, and a locking system. The pump actuator is capable of moving along a main longitudinal axis (X) from a rest position to a product dispensing position, and vice versa. The locking system for the actuator enables the actuator to be locked and/or unlocked. The locking system include an actuating means and a ring. The actuating means is capable of moving in a translational movement in a plane perpendicular to the main axis (X) from a locking position of the actuator to an unlocking position of the actuator, and vice versa. The ring capable of moving in a rotational movement about the main axis.

### CROSS-REFERENCE TO RELATED APPLICATIONS

This application claims priority to French Application No. 2410181, filed September 24, 2024, the contents of which is incorporated herein by reference in its entirety.

### TECHNICAL FIELD OF THE INVENTION

The invention relates to a dispensing head for a fluid product configured to be mounted on at least one fluid product reservoir of a dispenser. The invention also relates to a dispenser for a fluid product comprising such a dispensing head. The fluid product is of the lotion, gel, perfume or cream type, for example, used for cosmetic purposes or pharmaceutical treatments.

### TECHNICAL BACKGROUND

There are dispensing systems designed to equip dispensers used in perfumery, cosmetics or for pharmaceutical treatments containing a product.

Typically, the dispensing system comprises a push button, a pump, a piston and a dispensing conduit that allows product to flow from a reservoir in the dispenser in which the product is stored to a dispensing orifice.

The pushbutton can be moved between a lowered position and an upper position, with a return force returning it to its upper position. Its actuation allows the pump to be activated to drive the circulation of the product from the reservoir of the dispenser to the dispensing orifice and the dispensing of the product. The pump is generally manually operated by means of a push button.

One of the disadvantages of this type of system is that the push button can be accidentally pressed. Indeed, if the push button is not protected, pressure may be exerted, for example, when the dispenser is stored in a bag, causing the product to spill and not only dirtying the storage environment but also wasting the product.

There are various solutions to this problem.

For example, the push button can be protected with a protective cap. However, when fitting or removing the cap, it is also possible to inadvertently apply pressure to the push button. In addition, depending on the design of the dispensing orifice, it may be difficult to fit the cap.

There are also mechanisms for blocking pump and/or piston actuation. These mechanisms are generally complex, and make the manufacture of the dispenser complicated, but also the use of the dispenser, as the user does not necessarily know how to activate the push button. Because of their complexity, these mechanisms can also be fragile and deteriorate as the dispenser is used.

There is therefore a need for a solution that allows at least some of the disadvantages mentioned above to be overcome while retaining a dispenser that is simple to manufacture and use.

### SUMMARY OF THE INVENTION

Thus, the invention relates to a dispensing head for a fluid product configured to be mounted on at least one fluid product reservoir of a dispenser, the dispensing head comprising:

a pump actuator capable of moving along a main longitudinal axis from a rest position to a product dispensing position, and vice versa,

a locking system for the actuator allowing locking and/or unlocking of the actuator,

The locking system comprising:

an actuating means capable of moving in a translational movement in a plane perpendicular to the main axis from a locking position of the actuator to an unlocking position of the actuator, and vice versa,

a ring capable of moving in a rotational movement about the main axis,

The translational movement of the actuating means driving the rotational movement of the ring so that, in the unlocked position, at least one protuberance of the actuator is aligned with a slot of the ring so that the actuator can move from the rest position to the product dispensing position and, in the locking position, the protuberance is in abutment with an upper edge of the ring, preventing the actuator from moving from the rest position to the product dispensing position.

In other words, in the unlocking position, the alignment of the slots and protrusions allows the actuator to descend and move from the rest position to the dispensing position. On the other hand, in the locking position, the protuberances are in abutment with the upper edge of the ring, preventing the actuator from lowering. Thus, even if pressure is exerted on the actuator, it cannot be lowered, i.e., moved to the dispensing position of the fluid product.

This allows you to protect yourself, with a simple gesture, from any accidental activation of the actuator, for example, when storing the dispenser in a bag.

This solution also eliminates the need for a protective cap, which has to be removed to activate the actuator and can be lost or soiled when not fitted to the dispenser, or can cause the actuator to operate when it is replaced.

According to various embodiments, which may be taken together or separately:

the actuating means comprises a rigid finger extending radially towards the inside of the ring and cooperating with the ring so that the translational movement of the actuating means drives the rotational movement of the ring,

the actuating means comprises a rigid finger extending radially towards the inside of the ring and cooperating with a notch of the ring so that the translational movement of the actuating means drives the rotational movement of the ring,

the actuating means comprises a tab extending radially inwards from the ring and cooperating with a notch of the ring so that the translational movement of the actuating means drives the rotational movement of the ring,

the notch is located on a lower base plate of the ring, the ring further comprises an upper skirt comprising the slot and extending from the lower base plate towards the upper edge,

the diameter of the upper skirt is smaller than the diameter of the lower base plate,

the tab comprises a hole cooperating with a tenon projecting axially downwards from the lower base plate at the level of the notch,

the hole is through,

the hole extends axially,

the actuating means comprises a projection enabling a user to perform the translational movement of the actuating means,

the actuator comprises a nozzle for dispensing the fluid product, the projection of the actuating means being located opposite the nozzle,

the dispensing head comprises a flat side, the projection of the actuating means being located at the flat side,

the dispensing head comprises an external cover enveloping the actuator and locking system, the cover comprising a first window through which the projection of the actuating means is accessible,

the first window is dimensioned so as to allow the translational movement of the actuating means,

the cover comprises a second window through which the dispensing nozzle projects,

the second window is dimensioned so as to allow axial translational movement of the actuator when the actuator passes from the rest position to the product dispensing position, and vice versa,

the dispensing head comprises a push button in contact with the actuator on which a user exerts pressure so that the actuator moves from the rest position to the product dispensing position,

the dispensing head is made of a mono-material,

the mono-material is polypropylene.

The invention also relates to a dispenser for a fluid product comprising a fluid product reservoir and a dispensing head as described above, the dispensing head being mounted on the reservoir.

Advantageously, the dispenser comprises a dispenser pump attached to the dispensing head and actuated by pressure on the actuator.

### BRIEF DESCRIPTION OF THE FIGURES

Further characteristics and advantages of the invention will become apparent from the following detailed description, for the understanding of which reference is made to the attached drawings wherein:

FIG. 1 is a rear perspective view of a dispensing head according to the invention in the locked and rest position;

FIG. 2 is a perspective view of a locking system and an actuator of the dispensing head of FIG. 1;

FIG. 3 is a bottom view of FIG. 2;

FIG. 4 is a rear perspective view of the dispensing head in FIG. 1 in the unlocked and rest position;

FIG. 5 is a front perspective view of the dispensing head in FIG. 1 in the unlocked and rest position;

FIG. 6 is a perspective view of the locking system and the actuator of the dispensing head of FIGS. 4 and 5;

FIG. 7 is a bottom view of FIG. 6;

FIG. 8 is a perspective view similar to FIG. 6 with an additional part;

FIG. 9 is a rear perspective view of the dispensing head in FIG. 1 in the unlocked and product dispensing position;

FIG. 10 is a front perspective view of the dispensing head in FIG. 1 in the unlocked and product dispensing position;

FIG. 11 is a perspective view of the locking system and the actuator of the dispensing head of FIGS. 9 and 10 ;

FIG. 12 is a perspective view of an actuator of FIGS. 2, 6 and 11 ;

FIG. 13 is a perspective view of a ring of the locking system of FIGS. 2, 6 and 11;

FIG. 14 is a perspective view of a means of actuating the locking system of FIGS. 2, 6 and 11.

FIG. 15 is an exploded perspective view of a dispenser for a fluid product fitted with the dispensing head shown in FIGS. 1, 2, 4, 5, 9 and 10.

### DETAILED DESCRIPTION OF THE INVENTION

By convention, the “axial” direction in the figures corresponds to that of the main axis X of a dispenser for a fluid product, and the “radial” direction is orthogonal to the axial direction.

In the following detailed description of the figures, the terms “upper” and “lower” or “top” and “bottom” will be used without limitation in reference to the axial direction.

Similarly, the terms “outer or external” and “inner or internal” are used with reference to the radial direction, an outer element being radially further from the axis X than an inner element.

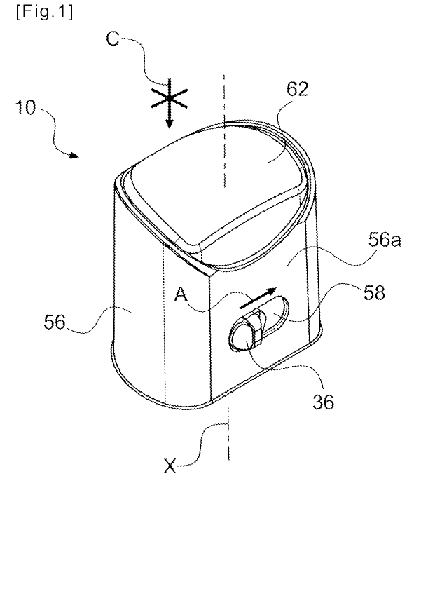

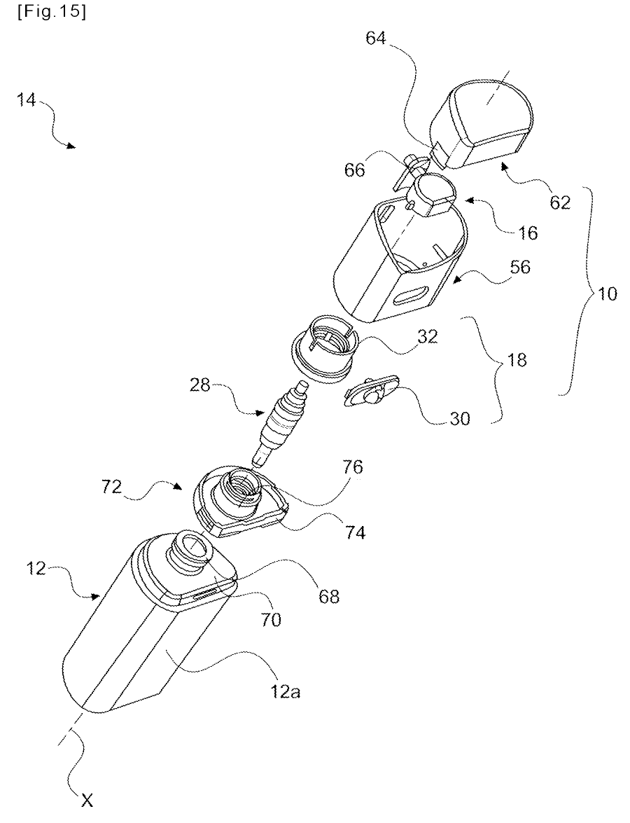

FIGS. 1, 4, 5, 9 and 10 illustrate a dispensing head 10 for a fluid product configured to be mounted on a reservoir 12 for a fluid product to form a dispenser 14. The dispenser 14 and reservoir are shown in FIG. 15.

The fluid product is of the lotion, gel, perfume or cream type, for example, used for cosmetic purposes or pharmaceutical treatments.

The dispensing head 10 comprises:

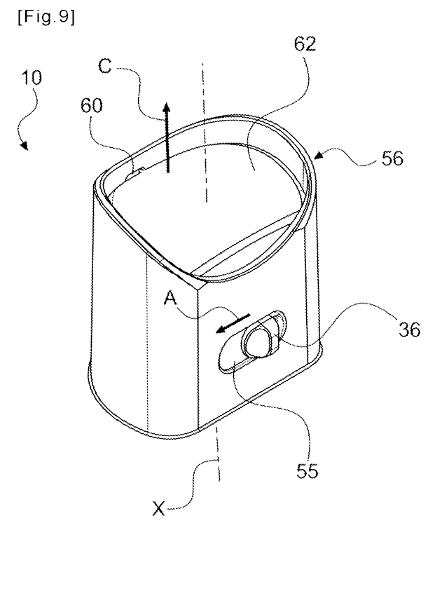

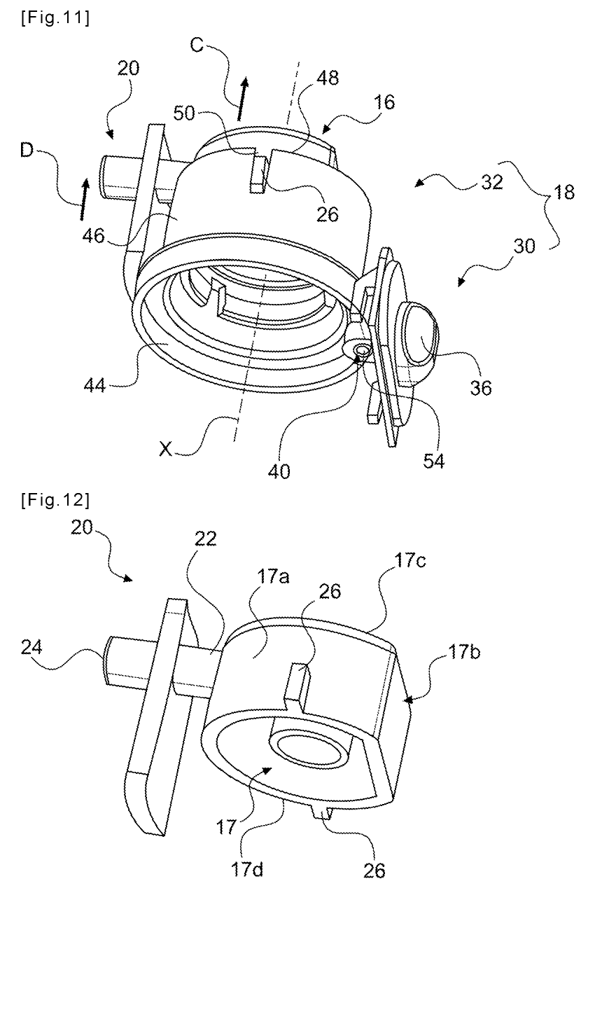

a pump actuator 16 (visible in FIG. 12) capable of moving along a main longitudinal axis X from a rest position (illustrated in FIGS. 1, 2, 4, 5, 6 and 8) to a product dispensing position (illustrated in FIGS. 9 to 11), and vice versa,

a locking system 18 for the actuator 16, allowing locking and/or unlocking of the actuator 16.

The movement along the main longitudinal axis X of the actuator is illustrated by the arrow C visible in FIGS. 1, 2, 4 to 6 and 8 to 11.

With reference to FIG. 12, the actuator 16 has an internal housing 17 delimited by a cylindrical lateral wall 17a with a flat face 17b. The lateral wall 17a extends from a transverse upper wall 17c to a lower edge 17d.

The actuator 16 also includes a nozzle 20 for dispensing the fluid product. The nozzle forms a duct 22 extending from a dispensing orifice 24 towards the internal housing.

The nozzle 20 protrudes from the external surface of the lateral wall 17a radially outwards.

Advantageously, the nozzle 20 is located on the lateral wall 17a opposite the flat face 17b.

The lateral wall 17a comprises, here, two opposed protuberances 26 projecting radially outwards from the external surface.

The protuberances 26 are arranged at 90° with respect to the nozzle 20, on either side of the flat face 17b. The protuberances 26 are flush with the lower edge 17d of the lateral wall 17a.

The axial displacement of the actuator 16 (along the arrow C) allows, when a pressure is exerted on it and it moves to the dispensing position, a pump 28 to be activated (only visible in FIG. 15) of the dispenser 14, allowing the rise and distribution of the fluid product contained in the reservoir 12 of the dispenser 14.

Advantageously, the pump 28 is housed in the housing 17 of the actuator 16. The pump 28 is fluidically connected to the conduit 22 of the nozzle 20 so that its actuation allows the cosmetic product stored in the reservoir 12 to be conveyed to the dispensing orifice 24 of the nozzle 20.

The locking system 18 comprises:

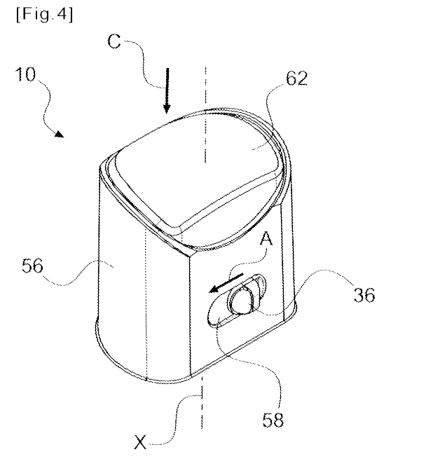

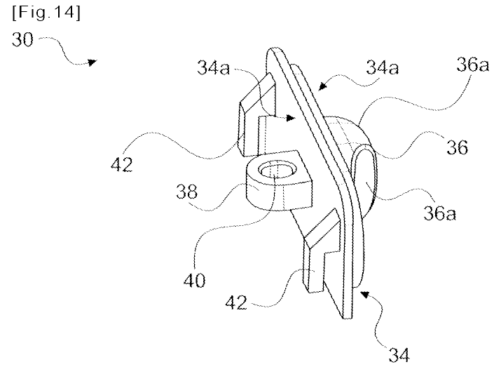

an actuating means 30 (visible in FIG. 14) capable of translational movement in a plane perpendicular to the main axis X from a locking position (illustrated in FIG. 1) of the actuator 16 to an unlocking position (illustrated in FIGS. 4 and 9) of the actuator 16, and vice versa,

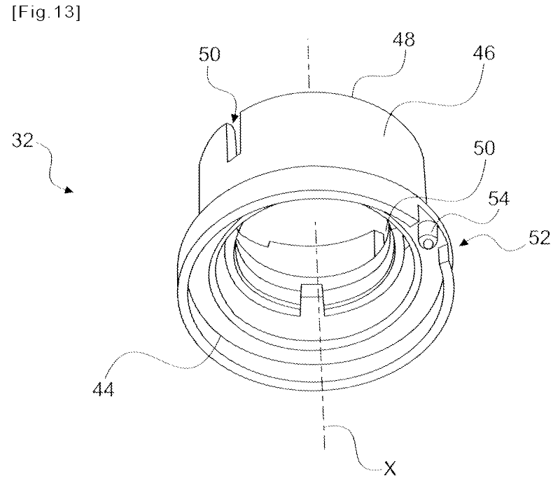

a ring 32 (visible in FIG. 13) capable of moving in rotational movement about the main axis X.

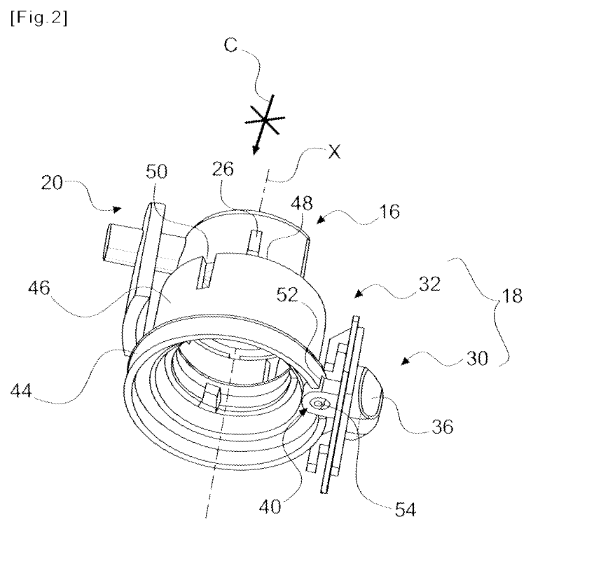

The locking system 18 can be seen in FIGS. 2, 6, 8, 11 and 15.

The translational movement of actuating means 30 is illustrated by the arrow A, visible in FIGS. 1, 3, 7 and 9.

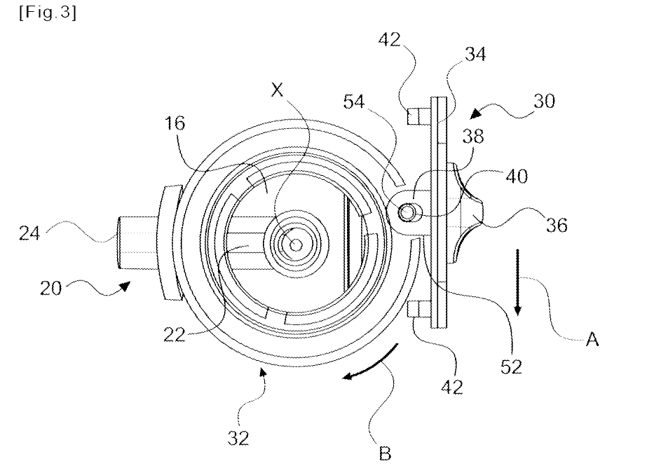

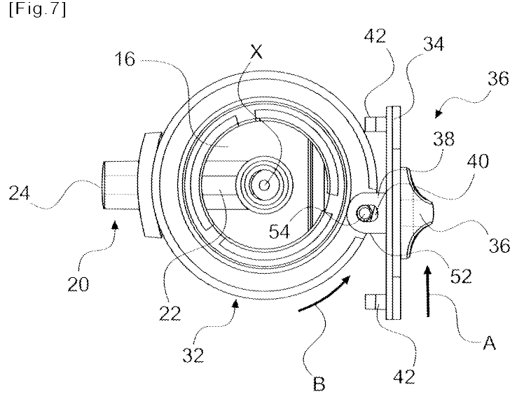

The rotational movement of ring 32 is illustrated by the arrow B in FIGS. 3 and 7.

With reference to FIG. 14, the actuating means 30 comprises a plate 34 extending laterally at the level of the flat face of the dispensing head 10.

In FIG. 14, the plate 34 has an inner face 34a directed towards the inside of the dispensing head 10 and an external face 34b directed towards the outside of the dispensing head 10.

The external face 34b comprises a projection 36 extending radially outwards from the external face 34b.

The projection 36 can be gripped by the user, enabling him to carry out the translational movement of the actuating means 30.

The projection 36 is located in the center of the external face 34b of the plate 34.

For good user handling, advantageously the projection 36 have two opposite concave sides 36a.

The internal face 34a comprises a tab 38 extending radially inwards from the dispensing head 10. The tab 38 is located in the centre of the internal face 34a of the plate 34.

The tab 38 comprises an axially extending through hole 40. Alternatively, the tab 38 may be solid, in the manner of a finger or any other mechanical design allowing for a rigid protrusion.

The plate 38 also includes two hooks 42. The two hooks 42 project inwards from the dispensing head 10 from an end on the inside to a free end pointing downwards. In other words, each hook 42 has a downwardly concave portion.

The two hooks 42 are located on either side of the tab 38, at each transverse end of the internal face of the plate 34.

With reference to FIG. 13, the ring 32 is cylindrical in shape and circular in cross-section.

The ring 32 comprises a lower base plate 44 and an upper skirt 46. The upper skirt 46 extending upwards from the lower base plate 44 to an upper edge 48. The diameter of the upper skirt 46 is smaller than the diameter of the lower base plate 44.

The upper edge 48 comprises two diametrically opposed slots 50. Each of the slots 50 extends axially from the upper edge 48 downward. In other words, each of the slots 50 is open at the upper edge 48 of the upper skirt 46.

The lower base plate 44 comprises a notch 52 located between the two slots 50. Notch 52 is opening towards the bottom.

The notch 52 comprises, in a complementary manner, a tenon 54 projecting axially downward from the lower base plate 44. This tenon 54 allows improved connection with the actuating means 30 via the tab 38.

According to the invention the translational movement of the actuating means 30 (according to the arrow A) drives the rotational movement (according to the arrow B) of the ring 32 so that, in the unlocked position, at least one protuberance 26 of the actuator 16 is aligned with a slot 50 of the ring 32 so that the actuator 16 can move from the rest position to the product dispensing position (according to the arrow C) and that in the locking position the protuberance 26 is in abutment with the upper edge 48 of the ring 32 preventing the actuator 16 from moving from the rest position to the product dispensing position.

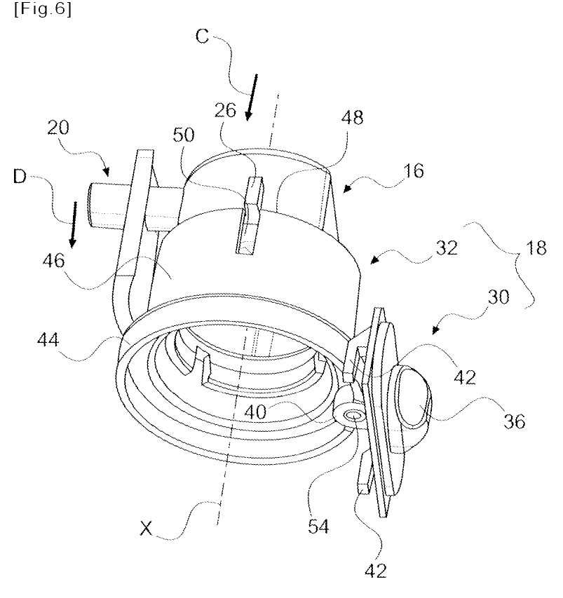

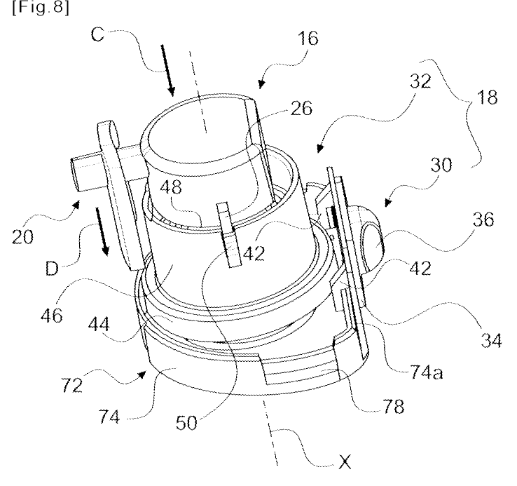

In other words, in the unlocked position illustrated in FIGS. 6 and 8, the alignment of the slots 50 and the protuberances 26 allows the actuator 16 to be lowered and move from the rest position to the dispensing position. On the other hand, in the locked position (shown in FIG. 2), the protuberances 26 are in abutment with the upper edge 48 of the ring 32, preventing the actuator 16 from lowering. So even if pressure is applied to the actuator 16, it cannot be lowered, i.e. moved into the dispensing position of the fluid product.

This allows you to protect yourself, with a simple gesture, from any accidental activation of the actuator 16, for example when storing the dispenser 14 in a bag.

This solution also eliminates the need for a protective cap, which has to be removed to activate the actuator 16 and is liable to be lost or soiled when it is not in place on the dispenser 14, or which may cause actuation of the actuator 16 when it is replaced.

Advantageously, the actuator 16 is mounted above the ring 32 and fits within a circle with a diameter smaller than that of the upper skirt 46 of the ring 32. In the unlocked position, when pressure is exerted on the actuator 16 and it moves to the dispensing position, it descends inside the ring 32 to activate the pump 28, allowing the rise and distribution of the fluid product contained in the reservoir 12 of the dispenser 14.

Advantageously, the tab 38 of the actuating means 30 cooperates with the notch 52 in the ring 32 so that the translational movement of the actuating means 30 drives the rotational movement of the ring 32 (as shown by arrow B in FIGS. 3 and 7).

Alternatively, as mentioned previously, it may be a rigid finger which cooperates with the ring 32 to cause its rotational movement.

In the example shown here, which can be seen in FIGS. 2, 3, 6, 7,and 11, the cooperation of the tab 38 with the notch 52 is facilitated by the tenon 54 in the notch 52, which meshes with the hole 40 opening from the tab 38. The tenon 54 facilitates the good holding of the actuating means 30, particularly during its translational movement and the rotational movement of the ring, with the ring 32.

In other words, when the user actuates the actuating means 30 by moving it from the locked position to the unlocked position, and vice versa, i.e. by carrying out a translation movement of it, this causes the ring 32 to rotate (according to the arrow B visible in FIGS. 3 and 7) and the alignment or not, here of the two slots 50 with the two protuberances 26 of the actuator 16.

The dispensing head 10 also comprises an external cover 56 enveloping the actuator 16 and the locking system 18.

The entire cover 56 can be seen in FIG. 15. It can also be seen in FIGS. 1, 4, 5, 9 and 10 assembled with the other parts to form the dispensing head 10.

The cover 56 is cylindrical in shape with a flat face 56a (reference visible in FIG. 1) similar to the actuator 16. The cover 56 extends axially from an open lower end to an open upper end. In other words, the cover 56 looks like a sleeve.

The cover 56 comprises a first window 58 (visible in FIGS. 1, 4 and 9) through which the projection 36 of the actuating means 30 is accessible. Preferably, the first window 58 is located on the flat face 56a. Preferably, the first window 58 is located in the lower part of the cover 56. The first window 58 extends horizontally (perpendicular to the main axis).

Advantageously, the first window 58 is dimensioned so as to allow a horizontal translational movement (perpendicular to the main axis) of the actuating means 30 when the actuator 16 moves from the rest position to the product dispensing position, and vice versa.

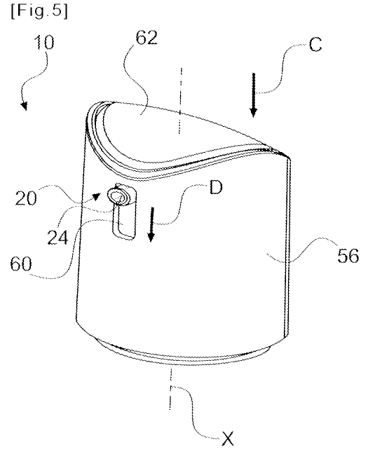

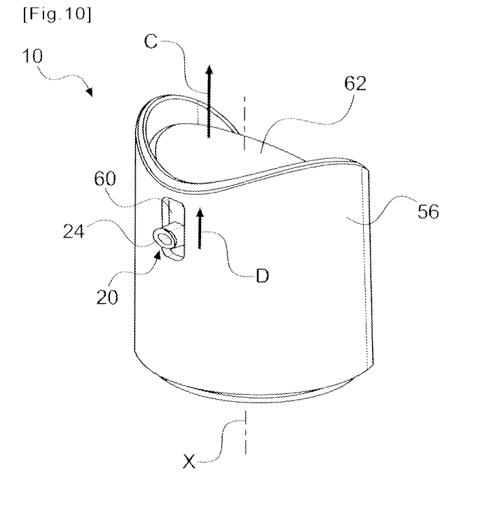

The cover 56 also includes a second window 60 (visible in FIGS. 5 and 10) through which the dispensing nozzle 20 projects. Preferably, the second window 60 is opposite the first window 58, i.e. opposite the flat face 56a. Preferably, the second window 60 is located at the top of the cover 56. The second window 60 extends vertically.

Advantageously, the second window 60 is dimensioned so as to allow an axial translational movement of the actuator 16 (according to the arrow C), in particular of the nozzle 20 (according to the arrow D), when the actuator 16 passes from the rest position to the product dispensing position, and vice versa (visible in FIGS. 5 and 10).

The dispensing head 10 may also include a push button 62.

The push button 62 can be seen in its entirety in FIG. 15. It can also be seen in FIGS. 1, 4, 5, 9 and 10 assembled with the other parts to form the dispensing head 10.

The push button 62 is in contact with the actuator 16 so that when a user exerts pressure on it, this causes the actuation of the actuator 16 that moves from the rest position to the product dispensing position. When the user releases the pressure on the push button 62, this causes the actuator 16 to move from the rest position to the product dispensing position.

The push button 62 has an internal housing delimited by a cylindrical lateral wall with a flat face similar to the shape of the actuator 16 and the cover 56. The lateral wall extends from a transverse upper wall to a lower edge.

The push button 62 fits into a circle with a diameter slightly smaller than that of the cover 56 so that it can be partially mounted therein and can move downwards thereinto when the user presses on it.

As can be seen in FIG. 15, the push button 62 also comprises two legs 64, each provided with a hook 66. The legs 64 extend from the lower edge of the push button 62 and are located diametrically opposite and on either side of the flat face of the push button 62.

The hooks 66 allow axial locking of the push button 62 relative to the cover 56 to ensure that it remains in place on the latter and cannot be removed.

The dispensing head 10 is configured to be mounted on a fluid product reservoir 12.

The dispensing head 10 can be clipped, screwed or attached in any other way known to the skilled in the art.

The reservoir 12 is here a cylinder comprising a flat face 12a, i.e. similar in shape to the actuator 16, the cover 56 and the push button 62.

The dispenser 14 thus has a general shape with a rounded front face on which the dispensing orifice 24 is arranged and a flat rear face where the actuating means 30 is arranged and where its projection is accessible to the user.

The reservoir 12 comprises a longitudinal wall, a closed bottom and an upper opening. The longitudinal wall delimits an internal volume in which the fluid product is stored. The upper opening is delimited by a neck 68 connected to the longitudinal wall by a flat, horizontal shoulder 70.

The assembly can be reversible, i.e. the dispensing head 10 can be removed from the reservoir 12 without destroying or deforming either of the two components.

In the example shown here, the dispenser 14 comprises a mounting platform 72, as shown in FIG. 15 or FIG. 8, assembled with the ring 32. The mounting platform 72 is located between the reservoir 12 and the dispensing head 10.

The mounting platform 72 comprises a lower base 74 surmounted by an upper cylindrical neck 76. The lower base 74 is similar in shape to the reservoir 12 and has a flat side 74a (visible in FIG. 8).

With reference to FIG. 8, advantageously, the two hooks 42 of the actuating means 30 are hooked onto the flat side 74a of the mounting platform 72. This facilitates the translational movement of the actuating means 30 and prevents it from getting in the way and causing the locking system 18 to malfunction. The flat side 74a of the mounting platform acts as a guide for the actuating means 30.

The mounting platform 72 may comprise, as shown here, openings 78 for securing and axially locking the cover of the dispensing head 10, for example two diametrically opposed openings on either side of the flat side. One of the lights can be seen in FIG. 8.

The diameter of the neck 76 of the mounting platform 72 is slightly larger than the diameter of the neck of the reservoir 12, so that the mounting platform 72 is positioned on the reservoir 12, with the neck 68 of the reservoir 12 inside the neck 76 of the mounting platform 72.

Advantageously, the mounting platform 72 is clipped onto the reservoir 12 by means of an internal annular bead (not visible) on the neck 76 of the mounting platform 72, which cooperates with an external annular bead (not visible) around the neck 68 of the reservoir 12.

1. A dispensing head for a fluid product configured to be mounted on a fluid product reservoir of a dispenser, the dispensing head comprising:
a pump actuator capable of moving along a main longitudinal axis from a rest position to a product dispensing position, and vice versa; and
a locking system for the actuator allowing locking and/or unlocking of the actuator, the locking system comprising:
an actuating means capable of moving in a translational movement in a plane perpendicular to the main axis from a locking position of the actuator to an unlocking position of the actuator, and vice versa; and
a ring capable of moving in a rotational movement about the main axis,
wherein the translational movement of the actuating means driving the rotational movement of the ring so that in an unlocked position at least one protuberance of the actuator is aligned with a slot of the ring so that the actuator can move from the rest position to the product dispensing position and that in the locking position the protuberance is in abutment with an upper edge of the ring preventing the actuator from moving from the rest position to the product dispensing position.

2. The dispensing head according to claim 1, wherein the actuating means comprises a tab extending radially inwards from the ring and cooperating with a notch of the ring so that the translational movement of the actuating means drives the rotational movement of the ring.

3. The dispensing head according claim 2, wherein the notch is located on a lower base plate of the ring, the ring further comprises an upper skirt comprising the slot and extending from the lower base plate towards the upper edge.

4. The dispensing head according to claim 3, wherein the tab comprises a hole cooperating with a tenon projecting axially downwards from the lower base plate at a level of the notch.

5. The dispensing head according to claim 1, wherein the actuating means comprises a projection enabling a user to perform the translational movement of the actuating means.

6. The dispensing head according to claim 5, wherein the actuator comprises a nozzle for dispensing the fluid product, the projection of the actuating means being located opposite the nozzle.

7. The dispensing head according to claim 5, comprising a flat side, the projection of the actuating means being located at the flat side.

8. The dispensing head according to claim 5, comprising an external cover enveloping the actuator and the locking system, the cover comprising a first window through which the projection of the actuating means is accessible.

9. The dispensing head according to claim 8, wherein the first window is dimensioned so as to allow the translational movement of the actuating means.

10. The dispensing head according to claim 8, wherein the cover comprises a second window through which the dispensing nozzle projects.

11. The dispensing head according to claim 10, wherein the second window is dimensioned so as to allow an axial translational movement of the actuator when the actuator passes from the rest position to the product dispensing position, and vice versa.

12. The dispensing head according to claim 1, comprising a push button in contact with the actuator on which a user exerts pressure so that the actuator moves from the rest position to the product dispensing position.

13. The dispensing head according to claim 1, the dispensing head being made of a mono-material.

14. A dispenser for a fluid product comprising a fluid product reservoir and a dispensing head according to claim 1, the dispensing head being mounted on the reservoir.

15. The dispenser according to claim 14, comprising a dispensing pump attached to the dispensing head and actuated by pressure on the actuator.
